(19) United States
(12) Patent Application Publication
(10) Pub. No.: US 2015/0083921 A1
(43) Pub. Date: Mar. 26, 2015

(54) APPROACHING VEHICLE DETECTION APPARATUS AND METHOD

(71) Applicant: DENSO CORPORATION, Kariya-city (JP)

(72) Inventor: Shinji OOYABU, Anjo-city (JP)

(21) Appl. No.: 14/494,964

(22) Filed: Sep. 24, 2014

(30) Foreign Application Priority Data
Sep. 26, 2013 (JP) 2013-199677
Oct. 31, 2013 (JP) 2013-226888

(51) Int. Cl. G01S 17/48; G01S 17/93; G01S 7/481; G01S 17/08

(52) U.S. Cl. CPC G01S 17/48; G01S 17/08; G01S 17/936; G01S 7/481
USPC 250/341.8; 250/338.1

(57) ABSTRACT

An approaching vehicle detection apparatus mounted to a subject vehicle includes a ranging device for detecting a distance to a different vehicle based on receipt of an infrared light reflected by the different vehicle, a communication device for exchanging an infrared signal with the different vehicle when the different vehicle approaches the subject vehicle within a first vehicle-to-vehicle distance, and a ranging synchronization device for making transmission timing of the infrared light differ from the subject vehicle to the different vehicle based on the signal of the communication device.

### CROSS REFERENCE TO RELATED APPLICATION

The present application is based on Japanese Patent Applications No. 2013-199677 filed on Sep. 26, 2013 and No. 2013-226888 filed on Oct. 31, 2013, disclosures of which are incorporated herein by reference.

### TECHNICAL FIELD

The present disclosure relates to an approaching vehicle detection apparatus and an approaching vehicle detection method for detecting approach of a vehicle in multiple vehicles.

### BACKGROUND

There is a conventional art (e.g., Patent Document 1) relating to a collision prediction apparatus. The collision prediction apparatus receives a light beam spot emitted from a different vehicle to measure an angle between a subject vehicle and the different vehicle and determine a collision probability based on an angle of a heading direction of the subject vehicle with respect to a heading direction of the different vehicle.

With a simple configuration, the collision prediction apparatus of the conventional art can predict a possibility of collision between the subject vehicle and the different vehicle in advance and improve vehicle safety.

Patent Document 1: JP-2010-13012A

The needs of equipment for detecting the approach of a vehicle in multiple vehicles are increasing year by year. This is largely due to increasing needs for a pre-clash safety system, which predict a collision in advance and takes preliminary measures against it, and advancing concepts for a driverless vehicle transportation system.

In this relation, in order to detect approaching of vehicles each other, it is conceivable to apply a method of detecting a distance between a vehicle and an obstacle by transmitting a reflective media such as an ultrasonic wave or the like and using the reflective media reflected by the obstacle outside the vehicle. Specifically, each vehicle transmits the reflective medium, and detects a distance to a difference vehicle based on the reflective medium reflected by the different vehicle.

However, when respective vehicles transmit the reflective mediums in order to detect the distance between vehicles, the reflective mediums transmitted from respective vehicles interfere with each other, making precise distance detection impossible. Specifically, when the reflective medium transmitted from the subject vehicle interferes with the reflective medium from a different vehicle, the reflective medium reflected may not be correctly incident on the subject vehicle or the reflective medium from the different vehicle may be wrongly detected as the reflective medium having being transmitted from the subject vehicle. When precise distance detection between vehicles cannot be performed, it may lead to reduction in accuracy of vehicle-to-vehicle approach detection. No measures against this difficultly are addressed in the above-mentioned conventional art.

Moreover, in order to implement a driverless vehicle transportation system, it is necessary to transmit information through vehicle-to-vehicle communication in addition to detecting the distance to a different vehicle. In some cases, when the communication is performed between nearby vehicles, it may be preferable to use infrared light instead of radio wave. Specifically, as compared with the radio wave, the infrared light tends not to spread and not travel a far distance, and thus, the infrared light is resistant to noise.

Nevertheless, since an infrared amount in environments affects an infrared light, an infrared light from a distant light source may arrive and unnecessary information may be also received when the infrared amount in environments is small. When the unnecessary reception increases, a function of a communication device may be saturated or a processor may use much memory for information processing, and as a result, a controller may not function normally.

### SUMMARY

In view of the foregoing, it is an object of the present disclosure to provide an approaching vehicle detection apparatus and an approaching vehicle detection method.

According to a first example of the present disclosure, an approaching vehicle detection apparatus mounted to a subject vehicle to detect a different vehicle approaching the subject vehicle comprises a ranging device, a communication device, and a ranging synchronization device. The ranging device detects a distance to the different vehicle based on receipt of an infrared light that is transmitted toward the different vehicle and reflected by the different vehicle. The communication device performs transmission and receipt of a signal of infrared light between the subject vehicle and the different vehicle to exchange information when the different vehicle approaches the subject vehicle within a first vehicle-to-vehicle distance. The ranging synchronization device makes transmission timing of the infrared light differ from the subject vehicle to the different vehicle, based on the signal of the communication device.

According to the above configuration, because the approaching vehicle detection apparatus makes the infrared light transmission timing differ from the different vehicle based on the signal of the communication device, interference of the infrared light transmitted between the vehicles can be prevented, and the infrared light reflected by the different vehicle can be incident on the subject vehicle correctly. For this reason, accurate distance detection between vehicles can be realized and the detection accuracy of the approach of the different vehicle can improve. Moreover, interference between the infrared light for the communication and the infrared light for the ranging can be prevented, and reliability of the communication between vehicles can improve. Moreover, since infrared light is resistant to disturbance, stable distance detection between vehicles can be realized at low cost.

According to a second aspect of the present disclosure, an approaching vehicle detection method comprises a ranging process, a communication process and a ranging synchronization process. The ranging process includes transmitting an infrared light between a subject vehicle and a different vehicle and detecting a distance to the different vehicle based on receipt of the infrared light that is reflected by the different vehicle. The communication process includes transmission and receipt of a signal of infrared light signal between the subject vehicle and the different vehicle to exchange information when the different vehicle approaches the subject vehicle within a first vehicle-to-vehicle distance. The ranging synchronization process includes making transmission timing of the infrared light differ from the subject vehicle to the different vehicle based on the signal transmitted and received in the communication process.

According to a third aspect of the present disclosure, an approaching vehicle detection apparatus mounted to a subject vehicle to detect a different vehicle approaching the subject vehicle comprises a ranging device, a communication device, a received strength detection device, an adjustment amount transmission device, and a strength adjustment device. The ranging device detects a distance to the different vehicle based on receipt of an infrared light that is transmitted toward the different vehicle and reflected by the different vehicle. The communication device performs transmission and receipt of a signal of infrared light between the subject vehicle and the different vehicle to exchange information when the different vehicle approaches the subject vehicle within a first vehicle-to-vehicle distance. The received strength detection device detects an infrared strength of the received signal from the different vehicle. The adjustment amount transmission device calculates an adjustment amount with regard to the received signal from the different vehicle based on the infrared strength of the received signal from the different vehicle and the distance to the different vehicle, and transmits the calculated adjustment amount to the different vehicle. The strength adjustment device adjusts an infrared strength of the transmitted signal, which is transmitted to the different vehicle, based on an adjustment amount of an infrared strength received from the different vehicle.

In the above approaching vehicle detection apparatus, because the infrared strength of the transmitted signal is adjusted based on the adjustment amount of the infrared strength received from the different vehicle, the infrared strength of the transmitted signal can be appropriately set and unnecessary reception in the vehicles can be reduced.

According to a fourth aspect of the present disclosure, an approaching vehicle detection method comprises a ranging process, a communication process, a received strength detection process, an adjustment amount transmission process, and a strength adjustment process. The ranging process includes transmitting an infrared light between a subject vehicle and a different vehicle and detecting a distance to the different vehicle based on receipt of the infrared light that is reflected by the different vehicle. The communication process includes performing transmission and receipt of a signal of infrared light between the subject vehicle and the different vehicle to exchange information when the different vehicle approaches the subject vehicle within a first vehicle-to-vehicle distance. The received strength detection process includes detecting an infrared strength of the received signal from the different vehicle in the communication process. The adjustment amount transmission process includes calculating an adjustment amount with regard to the received signal from the different vehicle based on the infrared strength of the received signal from the different vehicle and the distance to the different vehicle, and transmitting the adjustment amount to the different vehicle. The strength adjustment process includes adjusting an infrared strength of the transmitted signal, which is transmitted to the different vehicle, based on an adjustment amount of an infrared strength received from the different vehicle.

In the above approaching vehicle detection method, because the infrared strength of the transmitted signal is adjusted based on the adjustment amount of the infrared strength received from the different vehicle, the infrared strength of the transmitted signal can be appropriately set and unnecessary reception in the vehicles can be reduced.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an approaching vehicle detection apparatus of a first embodiment;

FIG. 2 is a diagram illustrating a principle of a ranging method by an optical device of an approaching vehicle detection apparatus;

FIG. 3 is a plan view illustrating a distance measurable area and a communicable area of an approaching vehicle detection apparatus;

FIG. 4 is a timing chart illustrating an approaching vehicle detection method in each vehicle;

FIG. 5 is a flow chart illustrating a collision avoidance method including approaching vehicle detection;

FIG. 6 is a block diagram illustrating a modification of the first embodiment;

FIG. 7 is a block diagram illustrating an approaching vehicle detection apparatus of a second embodiment.

FIG. 8 is a plan view illustrating a distance measurable area and a communicable area of an approaching vehicle detection apparatus;

FIG. 9 is a graph illustrating a relationship between an infrared strength and vehicle-to-vehicle distance;

FIG. 10 is a flowchart illustrating an infrared strength adjustment method performed by a controller of each vehicle;

FIG. 11 is a flowchart illustrating an infrared strength adjustment method of a first modification of the second embodiment; and

FIG. 12 is a flowchart illustrating an infrared strength adjustment method of a second modification of the second embodiment.

### DETAILED DESCRIPTION

### First Embodiment

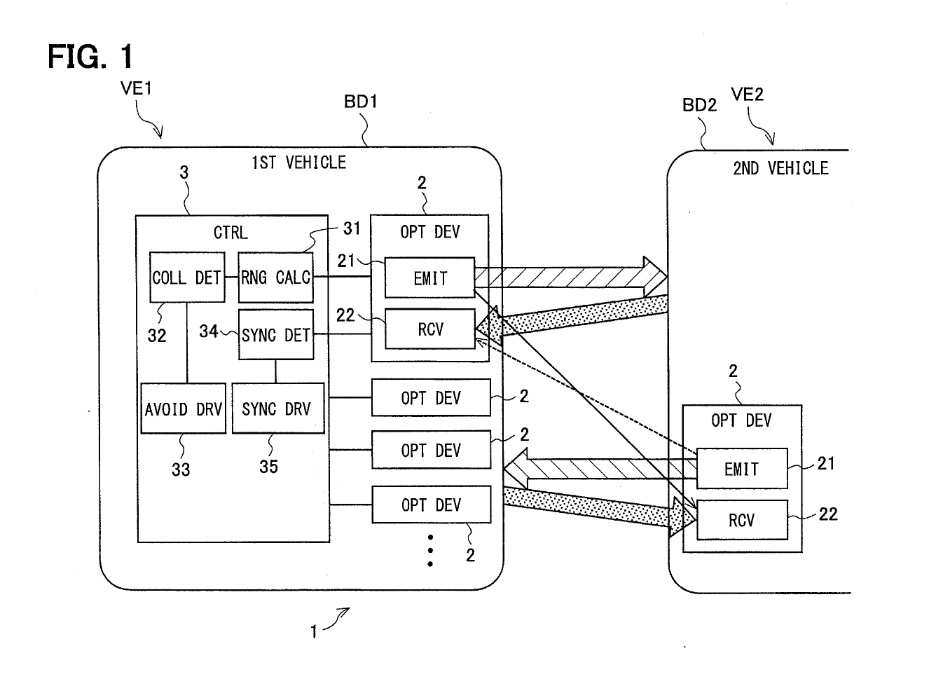

An approaching vehicle detection apparatus 1 of a first embodiment will be described based on FIG. 1 to FIG. 5. The approaching vehicle detection apparatus 1 of the present embodiment is mounted to a first vehicle VE1 and a second vehicle VE2 and has the same configuration in the first vehicle VE1 and the second vehicle VE2. Therefore, in the below description based on FIG. 1, except cases where explanation on both of the first vehicle VE1 and the second vehicle VE2 is necessary, only explanation on a configuration of the first vehicle VE1 may be given and explanation on a configuration of the second vehicle VE2 may be omitted. In the second vehicle VE2 of FIG. 1, the configuration except an optical device 2 is omitted. In the following, a vehicle VE1, VE2 may be used as a generic term of the first vehicle VE1 and the second vehicle VE2. Further, a subject vehicle VE1, VE2 may be used as a generic term of the first vehicle VE1 and the second vehicle VE2. A different vehicle VE2, VE1 may be used as a generic term of a counterparty of the subject vehicle.

As shown in FIG. 1, the approaching vehicle detection apparatus 1 of the present embodiment includes two or more optical devices 2. The optical device 2 corresponds to a ranging device, a ranging means, a communication device, and a communication means. Multiple optical devices 2 may not be necessarily required for each vehicle VE1, VE2. It may suffice that at least one optical device 2 is mounted to each vehicle VE1, VE2. The multiple optical devices 2 mounted to the first vehicle VE1 are arranged on an outer peripheral surface of the first vehicle VE1. The optical device 2 includes a light emitter 21 capable of transmitting infrared light and a light receiver capable of receiving infrared light. The light emitter 21 includes a transmission driver for infrared light and a modulation circuit for a digital signal for communication. The light receiver 22 includes a peak hold circuit and a filter circuit for ranging, and a demodulator circuit for the digital signal for communication.

The light emitter 21 of the first vehicle VE1 transmits the infrared light towards an outside of the first vehicle VE1. This infrared light is reflected by a body BD2 of the second vehicle VE2 and is incident on the light receiver 22. In this way, the first vehicle VE1 can detect the distance to the second vehicle VE2 nearby. Similarly, the infrared light emitted from the light emitter 21 of the second vehicle VE2 is reflected by a body BD1 of the first vehicle VE1 and is incident on the light receiver 22. In this way, the second vehicle VE2 can detect the distance to the first vehicle VE1 (cf. the arrows with hatching in FIG. 1).

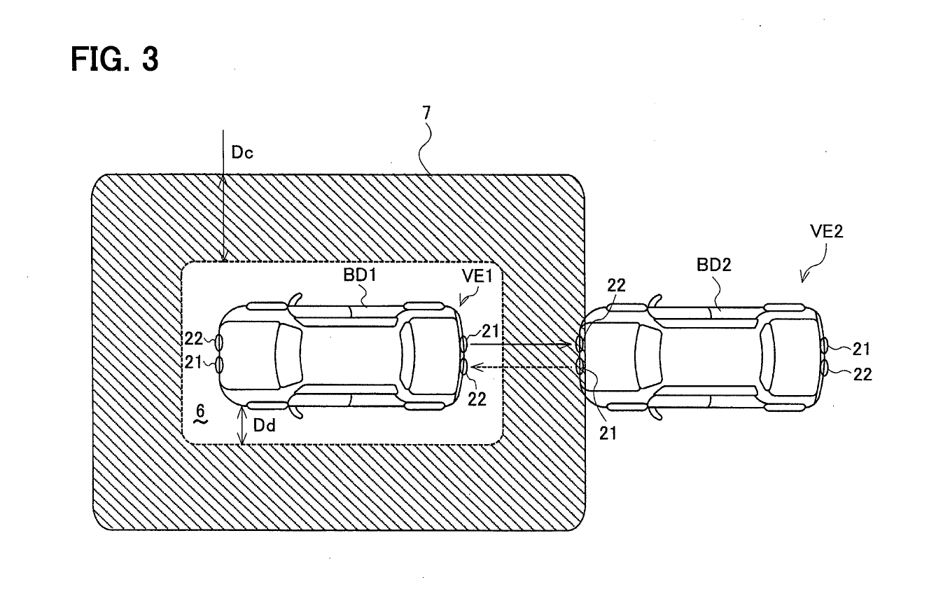

The infrared light transmitted from the light emitter 21 of either one of the first vehicle VE1 and the second vehicle VE2 is incident on the light receiver 22 of the other of the first vehicle VE1 and the second vehicle VE2, so that information exchange and communication can be performed between the first vehicle VE1 and the second vehicle VE2 (cf. the solid line or broken line arrows in FIGS. 1 and 3). Specifically, in each of the vehicle VE1, VE2, a single optical device 2 including the infrared light emitter 21 and the light receiver 22 is made to serve a double purpose as a ranging device and a communication device. For this reason, the single optical device 2 may include multiple light emitters 21 for different roles, which are the ranging and the communication. In this case, each optical device 2 can perform infrared transmission and reception for both of the ranging and the communication. Alternatively, the single light emitter 21 may be used to perform time-sharing transmission, thereby enabling infrared transmission and reception for both of the ranging and the communication. Alternatively, part of a detection element of the light receiver 22 may be used for the ranging and the rest may be used for the communication, so that the single light receiver 22 can be used for both of the ranging and the communication.

The controller 3 is connected to the optical device 2. The controller 3 is an electronic control unit with an I/O device, a processor, a storage etc. The controller 3 includes a ranging calculator 31, a collision determinator 32, and an avoid operation driver 33. The ranging calculator 31 calculates the distance between the first vehicle VE1 (subject vehicle) and the second vehicle VE2 (different vehicle) based on a detection value concerning the ranging by the light receiver 22. The collision determinator 32, which corresponds to a collision determination device and a collision determination means, determines whether there is a possibility of collision between the first vehicle VE1 and the second vehicle VE2, based on a calculation result of the ranging calculator 31. When the collision determinator 32 determines that there is a possibility of collision between the first vehicle VE1 and the second vehicle VE2, the avoid operation driver 33 operates a brake of the first vehicle VE1 irrespective of a driver's operation, or operates a steering apparatus of the first vehicle VE1 in order to avoid the collision. Additionally, the avoid operation driver 3 may warn the driver of the first vehicle VE1, or operate an airbag.

The controller 3 further includes a synchronization determinator 34, which determines whether it is necessary to make the infrared light transmission timing differ between the first vehicle VE1 and second vehicle VE2, based on the communication result by the light receiver 22. The controller 3 further includes a synchronous driver 35, which makes the infrared light transmission timing differ from the first vehicle VE1 to the second vehicle VE2 based on the determination result of the synchronization determinator 34. The synchronization driver 35 pre-stores a program for making the infrared light transmission timing differ. The synchronization determinator 34 and the synchronization driver 35 correspond to a ranging synchronization device and ranging synchronization means. In the present disclosure, the term “synchronize” refers to making the infrared light transmission timing differ from the vehicle VE1 to the vehicle VE2, so that the infrared lights for the ranging do not temporally overlap each other and that the infrared light for the ranging and the infrared light for the communication do not temporally overlap with each other.

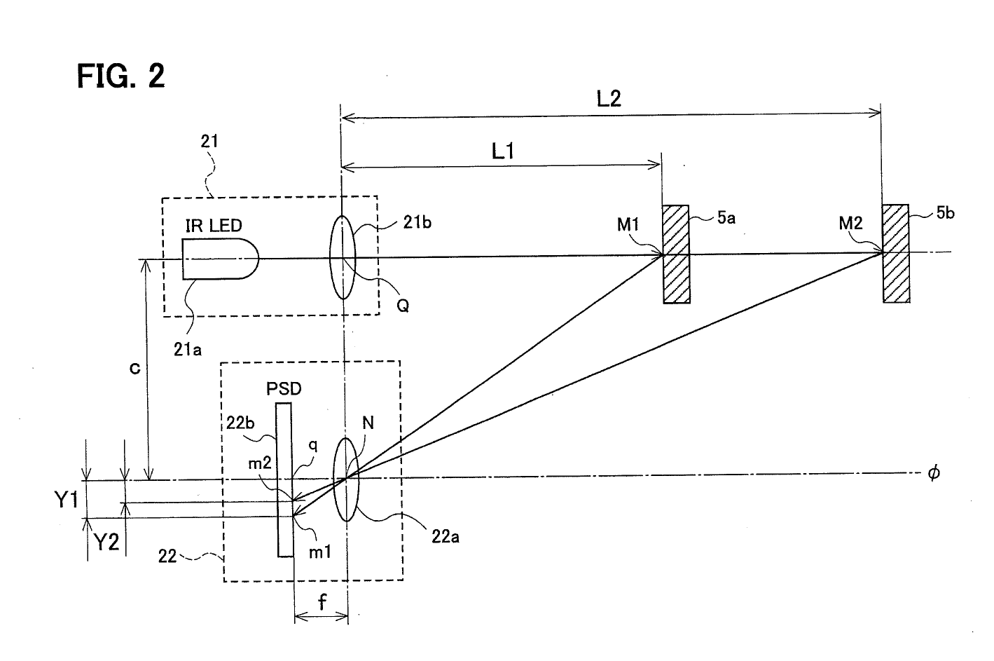

Now, based on FIG. 2, explanation will be given on a specific structure of the optical device 2 and a principle of the ranging manner using the optical device 2 by a triangulation method. In FIG. 2, a travel direction of the infrared light from the light source 21a (a left-to-right direction in FIG. 2) is a forward direction. The light emitter 21 of the optical device 2 includes a light source 21a formed with an infrared light emitting diode (IRLED). The light emitter 21 further includes the light transmission lens 21b located on a forward side of the light source 21a.

The light receiver 22 includes a light receiving lens 22a. The light receiving lens 22a is separated C from the light transmission lens 21b in a direction perpendicular to the traveling direction of the infrared light from the light source 21a. The light receiver 22 includes a photo detector 22b, which is located on a back side of the light receiving lens 22a and separated a focal length from the light receiving lens 22a. The photo detector 22b includes a position sensitive detector (PSD) and is capable of detecting a light quantity centroid position of the incident light spot.

As shown in FIG. 2, when the infrared light is sent out from the light source 21a, the infrared light reaches a first detecting object 5a located L1 from the light transmission lens 21b on a forward side, and is reflected by the first detecting object 5a. The reflected infrared light passes through the light receiving lens 22a and is incident on the photo detector 22b. At this time, it is detected that the centroid position of the spot of the incident infrared light is displaced by Y1 in a direction perpendicular to an optical axis φ of the light receiving lens 22a. In this case, a triangle M1-Q-N formed by the first detecting object 5a, the light transmission lens 21b and the light receiving lens 22a has a similarity relation with a triangle N-q-m1 formed by the light receiving lens 22a and the photo detector 22b. Therefore, an expression (L1/C)=(f/Y1) is met. From an expression L1=(f·C/Y1), a distance L1 to the first detecting object 5a is obtained.

Let us assume that a second detecting object 5b is located L2 (L2>L1) from the light transmission lens 21b in the forward direction. In this case, when the infrared light is sent out from the light source 21a, the infrared light is reflected by the second detecting object 5b and it is detected that the centroid position of the spot of the reflected infrared light is displaced by Y2 (Y2<Y1) in a direction perpendicular to an optical axis φ of the light receiving lens 22a. In this case, like the above-mentioned example, a triangle M2-Q-N formed by the second detecting object 5b, the light transmission lens 21b and the light receiving lens 22a has a similarity relation with a triangle N-q-m2 formed by the light receiving lens 22a and the photo detector 22b. Thus, an expression (L2/C)=(f/Y2) is met. From an expression L2=(f·C/Y2), a distance L2 to the second detection target 5b is obtained.

An infrared output of the light emitter 21 and a detection sensitivity of the light receiver 22 are adjusted so that the distance measurable area 6 (shown as a blank portion in FIG. 3) of the optical device 2 may be set to have a width Dd in the surrounding of the first vehicle VE1. Additionally, the infrared output of the light emitter 21 and the detection sensitivity of the light receiver 22 are adjusted so that an outer peripheral edge of the communicable area 7 is broader than an outer peripheral edge of the distance measurable area 6 by width Dc. In FIG. 3, the communicable area 7 is a sum total of the blank portion and the diagonal-line hatched portion. The above mentioned distance (Dc+Dd) or less corresponds to a first vehicle-to-vehicle distance or less. The distance Dd or less corresponds to a second vehicle-to-vehicle distance or less. Although not shown in the drawing, the distance measurable area 6 and the communicable area 7 are also set around the second vehicle VE2.

As mentioned above, the communicable area 7 of the present embodiment is set more widely than the distance measurable area 6. Thus, when the second vehicle VE2 approaches the first vehicle VE1, the communication function of the optical device 2 becomes usable earlier than the ranging function. It is conceivable that the communicable area 7 increases depending on environments of surroundings of the vehicles VE1, VE2, so that the communication is established with a vehicle located far away from the first vehicle VE1. In this case, the GPS-based position information of the counterparty vehicle is received, and the communication with the vehicle located far away may be cut off.

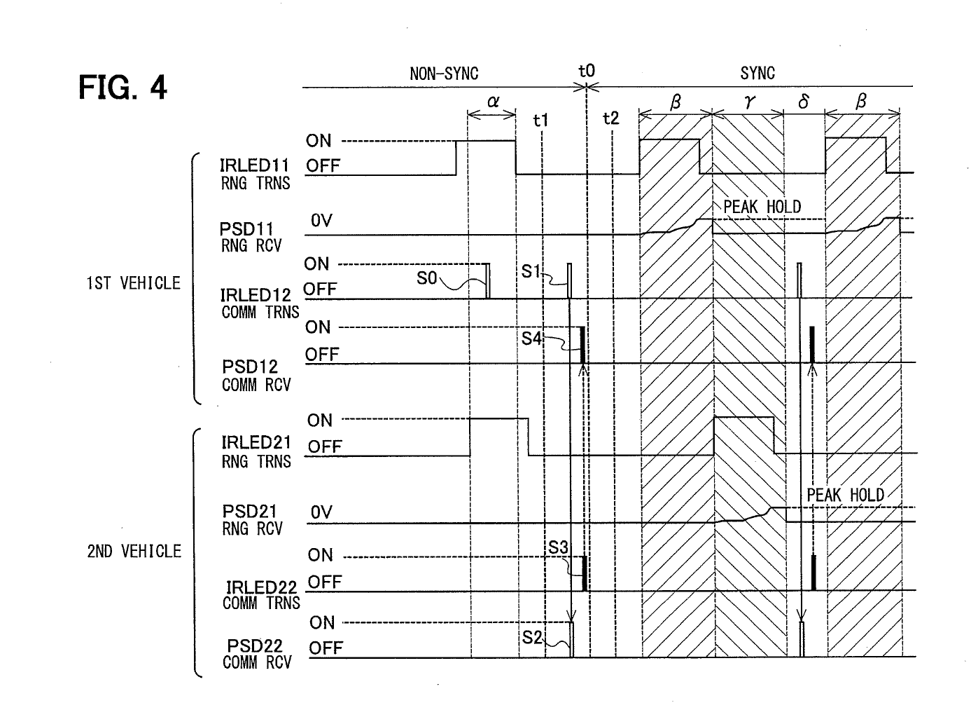

Next, based on FIG. 4, the time chart of the ranging method in the vehicle VE1, VE2 will be explained. In FIG. 4, the horizontal axis is a time axis, in which the time passes in a right direction. The IRLED11 RNG TRNS and the IRLED21 RNG TRNS of FIG. 4 show that the light is emitted during the rise of the waveform. The PSD11 RNG RCV and a PSD21 RNG RCV of FIG. 4 show that the approach of the different vehicle is detected when the waveform rises. The distance to the different vehicle detected by the light receiver 22 is held as a peak hold value until next receipt of the infrared light. The IRLED12 COMM TRNS, the PSD12 COMM RCV, the IRLED22 COM TRNS, and the PSD22 COMM RCV of FIG. 4 show that the transmission or reception is performed during the rise of the waveform.

In FIG. 4, a period after the time t0 is a synchronization period of the ranging and the communication between the vehicle VE1 and the vehicle VE2. A period before the time t0 is an non-synchronization period. In FIG. 4, in an early stage of the non-synchronization period, the vehicle VE2 does not enter into the communicable area 7 of the first vehicle VE1. Therefore, the communication is not established between the vehicles VE1 and VE2 and the ranging is performed irrespective of a different vehicle. Thus, the ranging light emission by the first vehicle VE1 and the ranging light emission by the second vehicle VE2 overlap temporally with other (shown as a period α). At this time, the second vehicle VE2 does not enter into the distance measurable area 6 of the first vehicle VE1, and both the vehicles VE1 and VE2 do not perform the ranging light reception. Additionally, because the first vehicle VE1 is communicating irrespective of the second vehicle VE2, the transmission of the first vehicle VE1 (shown as S0) temporally overlaps the ranging light emission of the second vehicle VE2.

At the time t1, when the second vehicle VE2 enters into the communicable area 7 of the first vehicle VE1, the first vehicle VE1 transmits a request message (S1) and the second vehicle VE2 receives the request message (S2), and thereafter, the second vehicle VE2 transmits a response message (S3) and the first vehicle VE1 receives the response message (S4). Accordingly, the communication is established between the vehicles VE1 and VE2. Through the request message and the response message, a method of synchronization of the ranging and the communication is determined between the vehicles VE1 and VE2.

When the time enters the synchronization period, the rangings are performed time-divisionally based on the method of synchronization between the vehicles VE1 and VE2. Therefore, after the second vehicle VE2 enters into the distance measurable area 6 of the first vehicle VE1 at the time t2, the period β for the ranging by the first vehicle VE1 does not overlap the period γ for the ranging by the second vehicle VE2.

Moreover, the communication between vehicle VE1 and VE2 is also performed time-divisionally, the period δ for the transmission and reception (communication) between the vehicles VE1 and VE2 does not overlap the periods β, γ for the ranging by the vehicle VE1, VE2.

The synchronization driver 35 of each vehicle VE1, VE2 pre-stores a program for stopping the light emitter 21 from sending out the infrared light, where the infrared light is sent out for detecting a distance to a different vehicle. For example, either one of the vehicles VE1, and VE2 may stop sending out the infrared light for the ranging during the communication period δ in the synchronization period, so that the detection value of the ranging by the different vehicle is transmitted as a ranging data to the vehicle having stopped sending out the infrared light and becomes usable in both the vehicles VE1 and VE2.

In the embodiment, as described above, the ranging may be performed in both vehicles VE1 and VE2, and the detection values of the ranging may be exchanged through the communication and compared with each other, so that a more precise collision determination can be performed.

In the above, the explanation is given on cases where the vehicle El is a master vehicle, which carries forward the synchronization of the ranging and the communication. In this relation, when the vehicles VE1, VE2 approach each other, each vehicle enters into the communicable area 7 of the counterparty vehicle. In such cases, the request message from the second vehicle VE2 may be received by the first vehicle VE1 early and the second vehicle VE2 may act as the mater vehicle to carry forward the synchronization of the ranging and the communication.

In some cases, the request messages transmitted from the vehicles VE1 and VE2 may be simultaneously received by the counterparty vehicles. In such cases, in order to carry forward the synchronization of the ranging and the communication, the program may set the master vehicle in such manners that the master vehicle is set to a vehicle that receives the request message from its front part, or the mater vehicle is set, based on the vehicle position detected by GPS, to a most northerly or easterly vehicle among the vehicles simultaneously receiving the request messages.

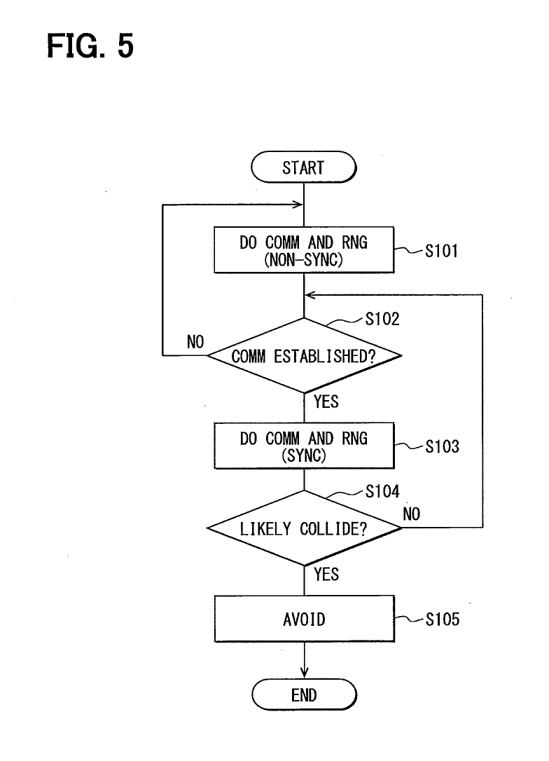

Next, based on FIG. 5, explanation will be given on a collision avoidance method including the approaching vehicle detection method, which is performed by the controller 3 of the first vehicle VE1 to detect approach of the second vehicle VE2 and avoid collision with the second vehicle VE2. First, during non-establishment of the communication with the second vehicle VE2, the controller 3 performs the ranging and the communication using the optical device 2 (S101: ranging process). When the second vehicle VE2 enters into the communicable area 7 of the first vehicle VE1, the exchange of the request message and the response message is performed between the vehicles VE1 and VE2, as mentioned above. Based on this, at Step S102, the controller 12 determines that the communication is established between the vehicles VE1 and VE2 (communication process). In this case, based on the signals in the communication between the vehicles VE1 and VE2, the ranging and the communication are performed in the synchronization, in which the time is divided for the vehicles VE1 and VE2 (S103: ranging synchronization process). When it is determined at S102 that the communication is not established between vehicles VE1 and VE2, the ranging and the communication in the non-synchronization continues to be performed until the communication is established between vehicles VE1 and VE2.

When the second vehicle VE2 enters into the distance measurable area 6 of the first vehicle VE1 after the ranging and the communication in the synchronization are started, the optical device 2 of the first vehicle VE1 detects the approach of the second vehicle VE2. Based on the detection result, calculation of the distance between the vehicles VE1 and VE2 is started. When it is determined based on the calculation result that there is a possibility of a collision between the first vehicle VE1 and the second vehicle VE2 (S104), the avoidance operation for avoiding the collision is performed with the avoid operation driver 33 of the first vehicle VE1 (S105). When the second vehicle VE2 does enter into the distance measurable area 6 of the first vehicle VE1 and the approach of the second vehicle VE2 is not detected, or when the approach of the second vehicle VE2 is detected but it is determined that there is no possibility of a collision between the first vehicle VE1 and the second vehicle VE2 at S104, the process returns to S102.

In the embodiment, after the second vehicle VE2 enters into the communicable area 7 of the first vehicle VE1 but before the second vehicle VE2 enters into the distance measurable area 6 of the first vehicle VE1, the reclined seat may be returned toward its upright position or a headrest may be moved forward.

The approaching vehicle detection apparatus 1 of the present embodiment, which may be mounted to each of multiple vehicles VE1 and VE2, includes the optical device 2, the synchronization determinator 34, and the synchronization driver 35. The optical device 2 transmits the infrared light toward the different vehicle VE2, VE1 and receives the infrared light reflected by the different vehicle VE2, VE1, thereby detecting the distance to the different vehicle VE2, VE1. When the different vehicle VE2, VE1 approaches within the communicable area 7, the optical device 2 performs transmission and reception of a signal of infrared light between the vehicle VE1 and the vehicle VE2 to exchange information. Based on the optical device 2, the synchronization determinator 34 and the synchronization driver 35 make the infrared light transmission timing differ from different vehicle VE2, VE1.

According to the above configuration, because the infrared light transmission timing is changed to differ from the different vehicle VE2, VE1 based on the signal of the optical device 2, interference of the infrared light transmitted between the vehicles VE1, VE2 can be prevented, and the infrared light reflected by the different vehicle VE2, VE1 can be incident on the subject vehicle VE1, VE2 correctly. For this reason, accurate distance detection between vehicles VE1, VE2 can be realized and the detection accuracy of the approach of the different vehicle VE2, VE1 can improve. Moreover, interference between the infrared light for the communication and the infrared light for the ranging can be prevented, and reliability of the communication between vehicles VE1, VE2 can improve. Moreover, since infrared light is resistant to disturbance, stable distance detection between vehicles VE1, VE2 can be realized at low cost.

Moreover, when the different-vehicle VE2, VE1 approaches within the distance measurable areas 6 smaller than the communicable area 7 after the different-vehicle VE2, VE1 approaches within the communicable area 7, the optical device 2 detects the distance to the different-vehicle VE2, VE1. Therefore, at a time of starting detecting the distance to the different-vehicle VE2, VE1, the synchronization has already started. Accordingly, ranging can be performed with high detection accuracy.

Moreover, because the synchronization driver 35 of each vehicle VE1, VE2 pre-stores a program for making the infrared light transmission timing differ between the vehicles VE1, VE2, it is possible to minimize an amount (volume) of information to be exchanged between the vehicles VE1, VE2 for the synchronization.

Moreover, in the vehicle VE1, VE2, the single optical device 2 including the light emitter 21 and the light receiver 22 plays roles of both the ranging and the communication, the approaching vehicle detection apparatus 1 can be downsized and provided at low cost.

Moreover, the approaching vehicle detection apparatus 1 includes the collision determinator 32, which determines a possibility of a collision with the different vehicle VE2, VE1 based on the detection result of the distance to the different vehicle VE2, VE1. Therefore, the danger of the collision with the different-vehicle VE2, VE1 can be avoided beforehand and the safety of the vehicle VE1, VE2 can improve.

Moreover, the synchronization driver 35 pre-stores a program for stopping sending out the infrared light, wherein the infrared light is sent out for detecting the distance to the different vehicle VE2, VE1. Either one of the vehicle VE1 and the vehicle VE2 stops sending out the infrared light for the ranging during the communication period δ in the synchronization period, so that the detection value of the ranging by the different vehicle VE2, VE1 is transmitted as a ranging data to the vehicle having stopped sending out the infrared light and becomes usable in both the vehicles VE1 and VE2.

Moreover, an approaching vehicle detection method of the present embodiment includes a ranging process (S101), a communication process (S102), and a ranging synchronization process (S103). In the ranging process, an infrared light is transmitted between a subject vehicle VE1, VE2 and a different vehicle VE2, VE1, and a distance to the different vehicle VE2, VE1 is detected based on receipt of the infrared light that is reflected by the different vehicle VE2, VE1. In the communication process, transmission and receipt of a signal of infrared light between the subject vehicle VE1, VE2 and the different vehicle VE2, VE1 is performed to exchange information when the different vehicle VE2, VE1 approaches within the communicable area 7 of the subject vehicle VE1, VE2. In the ranging synchronization process, transmission timing of the infrared light differs from the different vehicle VE2, VE1 based on the signal transmitted and received in the communication process. According to the above method, interference of the infrared light transmitted between the vehicles VE1, VE2 can be prevented, and the infrared light reflected by the different vehicle VE2, VE1 can be incident on the subject vehicle correctly. For this reason, accurate distance detection between vehicles can be realized and the detection accuracy of the approach of the different vehicle can improve.

<Modifications of First Embodiment>

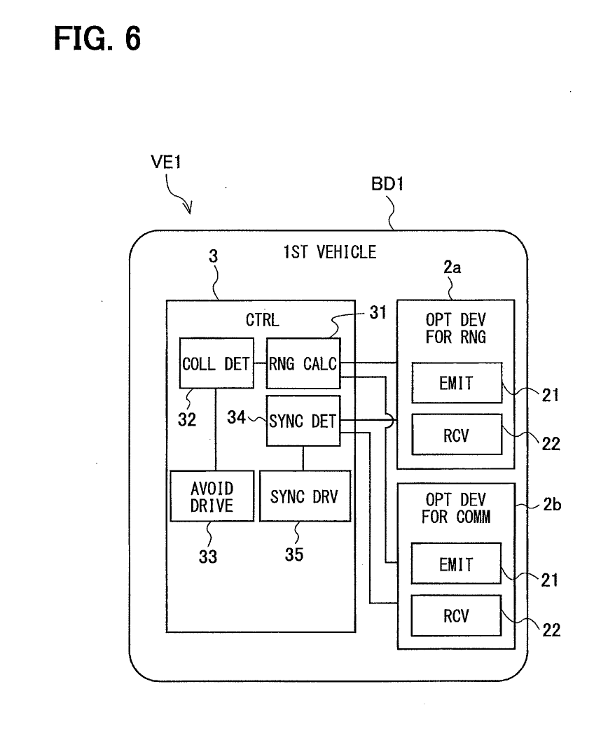

FIG. 6 illustrates a modification of the above-mentioned first embodiment. In FIG. 6, only the first vehicle VE1 is depicted and the second vehicle VE2 is omitted. In FIG. 1 and FIG. 6, like references are used to refer to like parts. In the approaching vehicle detection apparatus 1 of this modification, each vehicle VE1, VE2 is equipped with an optical device 2a for ranging, and an optical device 2b for the communication. As for other points, this modification is the same as the above mentioned embodiment. Each of the optical device 2a for ranging and the optical device 2b for the communication includes the light emitter 21 and the light receiver 22 like those in the above mentioned embodiment. In the vehicle VE1 and VE2, the ranging is performed with the optical device 2a for ranging to detect a distance to the different-vehicle VE2, VE1. The communication with the different-vehicle VE2, VE1 is performed with the optical device 2b for the communication.

According to the approaching vehicle detection apparatus 1 this modification, because the vehicle VE1, VE2 is equipped with the optical device 2a for ranging and the optical device 2b for the communication, the optical device 2a for ranging can be attached a part of the vehicle VE1, VE2 most suitable to perform the ranging for the different vehicle VE2, VE1, and the optical device 2b for the communication can be attached to a part of the vehicle VE1, VE2 most suitable to perform the communication with the different vehicle VE2, VE1. For this reason, in the approaching vehicle detection apparatus 1, the ranging accuracy can improve and the performance of the communication with the different-vehicle VE2,VE1 can improve.

<Further Modifications of First Embodiment>

The above illustrated first embodiment and modifications thereof do not limit embodiments and can be modified and extended in various ways.

In place of IRLED, the light source 21a may include a laser light source or a filament type infrared light source. In place of PSD, the photo detector 22b may include a CMOS image sensor or a CCD sensor. The approaching vehicle detection apparatus 1 is applicable to a driverless vehicle as well as a manned vehicle.

The approaching vehicle detection apparatus and method may be applied to approaching vehicle detection in three or more vehicles.

A method for the synchronization driver 35 to make the ranging and communication timing differ between the vehicles VE1, VE2 is not limited to performing the ranging and the communication in a time divisional manner, in which the time is divided in advance. In other embodiments, at each time when the ranging or the communication by one of the vehicles VE1, VE2 is ended, the other of the vehicles VE2, VE1 is notified of it. After being notified of it, the other of the vehicles VE2, VE1 starts performing the ranging or the communication.

In other modifications, in determining whether or not there is a possibility of a collision between the first vehicle VE1 and the second vehicle VE2, the collision determinator 32 may take into account not only the detected distance between the first vehicle VE1 and the second vehicle VE2 but also a speed, a steering wheel position, a gear shifter position, a heading direction or the like of each vehicle VE1 and VE2.

### Second Embodiment

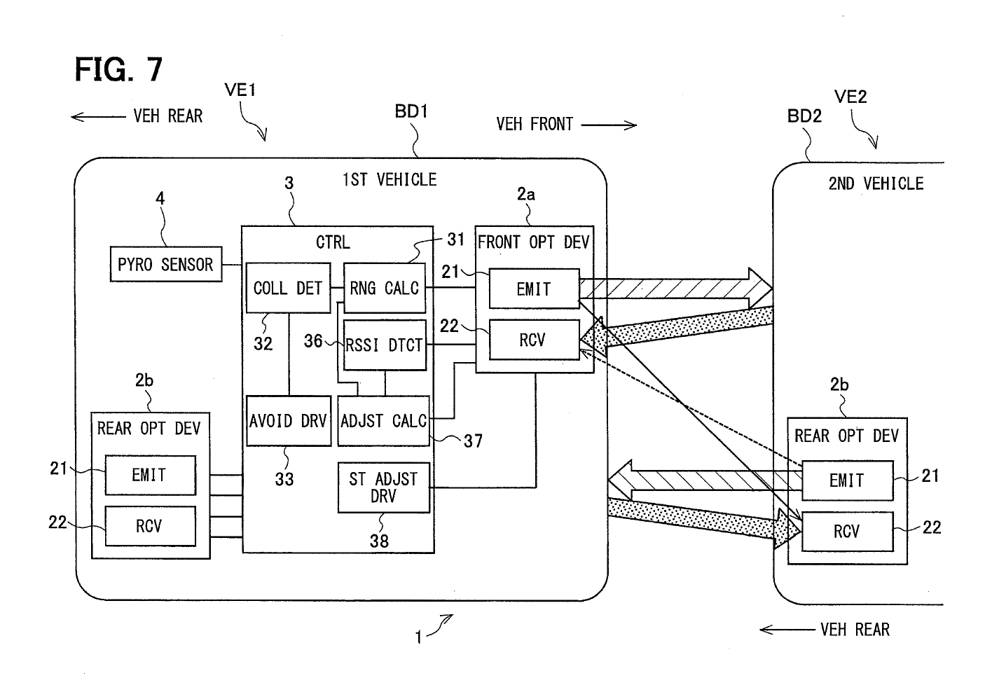

Based on FIG. 7 to FIG. 10, an approaching vehicle detection apparatus 1 of a second embodiment will be explained. The approaching vehicle detection apparatus 1 of the present embodiment is mounted to a first vehicle VE1, a second vehicle VE2 and a third vehicle VE 3, and has the same configuration among the first vehicle VE1, the second vehicle VE2 and the third vehicle VE3. Therefore, in the below description based on FIG. 7, except cases where explanation on the first vehicle VE1, the second vehicle VE2 and the third vehicle VE3 is necessary, only explanation on a configuration of the first vehicle VE1 may be given and explanation on a configuration of the second vehicle VE2 and the third vehicle VE3 may be omitted. In the second vehicle VE2 of FIG. 7, the configuration except an optical device 2 is omitted.

In the following, an optical device 2a, 2b may be used as a genetic term of a front optical device 2a and a rear optical device 2b. A vehicle VE1, VE2, VE3 or a subject vehicle may be used as a genetic term of the first vehicle VE1, the second vehicle VE2 and the third vehicle VE3. A different vehicle VE3, VE2, VE1 may be used to refer to a vehicle other than the subject vehicle VE1, VE2, VE3.

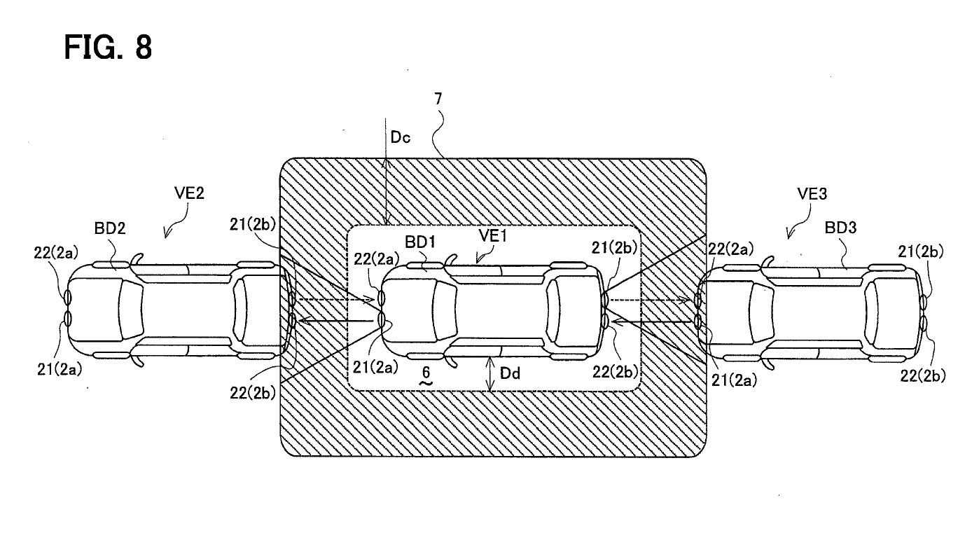

As shown in FIG. 7 and FIG. 8, each vehicle VE1, VE2, VE3 is equipped with a forward optical device 2a and a rearward optical device 2b. The forward optical device 2a and the rearward optical device 2b may have the same configuration. However, the forward optical device 2a and the rearward optical device 2b may not be necessarily required for each vehicle VE1, VE2, VE3. It may suffice that at least one of the forward optical device 2a and the rearward optical device 2b is mounted to each vehicle VE1, VE2, VE3. The forward optical device 2a mounted to the first vehicle VE1, which corresponds to a ranging means, a communication means, a forward ranging device and a forward communication device, is mounted to a front end part of the first vehicle VE1 and includes a light emitter 21 capable of emitting infrared light and a light receiver 22 capable of receiving an infrared light.

The light emitter 21 includes a light source (not shown) formed with an infrared light emitting diode (IRLED). As shown in FIG., a communicable area 7 determined by a maximum communication distance (Dc+Dd) depends on light distribution characteristic of the light emitting diode and may have a cone shape that widens in a forward direction and a rearward direction of the first vehicle VE1. The light emitter 21 includes a transmission driver for infrared light and a modulation circuit for a digital signal for communication.

The light receiver 22 includes a photo detector including a PSD (Position Sensitive Detector) formed with a photo diode. The light receiver 22 detects a light amount centroid position of the incident light spot. The light receiver 22 includes a peak hold circuit and a filter circuit for the ranging, and a demodulator circuit for the digital signal for the communication. The rearward optical device 2b mounted to the first vehicle VE1 (which corresponds to a ranging means, a communication means, a rearward ranging device, and a rearward communication device) is mounted to a rear end part of the first vehicle VE1, and includes a light emitter 21 and light receiver 22 like the forward optical device 2a.

The light emitter 21 of the forward optical device 2a of the first vehicle VE1 transmits the infrared light towards an outside of the first vehicle VE1. This infrared light is reflected by a body BD2 of the second vehicle VE2 and is incident on the light receiver 22. In this way, the first vehicle VE1 can detect the distance to the approaching second vehicle VE2. The detection of the distance to the second vehicle VE2 is performed with a triangulation method. Similarly, the infrared light emitted from the light emitter 21 of the rearward optical device 2b of the second vehicle VE2 is reflected by a body BD1 of the first vehicle VE1 and is incident on the light receiver 22. In this way, the second vehicle VE2 can detect the distance to the first vehicle VE1 (cf. the arrows with hatching in FIG. 7).

The infrared light transmitted from the light emitter 21 of either one of the forward optical device 2a of the first vehicle VE1 and the rearward optical device 2b of the second vehicle VE2 is incident on the light receiver 22 of the other of the first vehicle VE1 and the second vehicle VE2, so that information exchange and communication can be performed between the first vehicle VE1 and the second vehicle VE2 (cf. the solid line and the broken line arrows in FIGS. 7 and 8). Specifically, in each of the vehicles VE1, VE2, a single optical device 2a, 2b including the infrared light emitter 21 and the light receiver 22 is made to serve a double purpose as a ranging device and a communication device.

Each optical device 2a, 2b may include multiple light emitters 21 for different roles, which are the ranging and the communication. In this case, each optical device 2 can perform infrared transmission and reception for both of the ranging and the communication. Alternatively, the single light emitter 21 may be used to perform time-sharing transmission, thereby enabling infrared transmission and reception for both of the ranging and the communication. Alternatively, part of a detection element of the light receiver 22 may be used for ranging and the rest may be used for the communication, so that the single light receiver 22 can perform infrared transmission and reception for both of the ranging and the communication.

In the same way as described above, each of the rearward optical device 2b of the first vehicle VE1 and the forward optical device 2a of the third vehicle VE3 (cf. FIG. 8) can function as both of the ranging device and the communication device.

Regardless of the present embodiment, when multiple optical devices 2a, 2b are attached in an outer peripheral portion of the first vehicle VE1, an infrared output of the light emitter 21 and a detection sensitivity of the light receiver 22 are adjusted so that a distance measurable area 6 (shown as a blank in FIG. 8) of the optical device 2a, 2b is set to have a width of Dd (maximum range) in the surrounding of the first vehicle VE1. Additionally, the infrared output of the light emitter 21 and the detection sensitivity of the light receiver 22 are adjusted so that an outer peripheral edge of the communicable area 7 is broader than an outer peripheral edge of the distance measurable area 6 by width Dc. In FIG. 7, the communicable area 7 is a sum total of the blank portion and the diagonal-line hatched portion. The above mentioned distance (Dc+Dd) or less corresponds to a first vehicle-to-vehicle distance or less. The distance Dd or less corresponds to a second vehicle-to-vehicle distance or less. Although not shown in the drawing, the distance measurable area 6 and the communicable area 7 are also set around the second vehicle VE2 and the third vehicle VE3.

As mentioned above, the communicable area 7 of the present embodiment is set wider than the distance measurable area 6. Thus, when the second vehicle VE2 or the third vehicle VE3 approaches the first vehicle VE1, the communication function of the optical device 2a, 2b becomes usable earlier than the ranging function.

It may be preferable that depending on environments of the vehicle VE1, VE2, VE, the maximum communicable distance (Dc+Dd) should be set each time. For example, when the vehicle VE1, VE2, VE3 is running a highway, the maximum communicable distance (Dc+Dd) is set to a large distance. When the vehicle VE1, VE2, and VE3 is running at a low speed, the maximum communication distance (Dc+Dd) is set to a relatively-small distance.

Moreover, it is conceivable that depending on infrared environments of the surrounding of the vehicle VE1, VE2, VE3, the communicable area 7 may increases, and the communication with a vehicle far away from the first vehicle VE1 may be established. The present embodiment cuts off the communication with the far away vehicle.

Explanation returns to FIG. 7. The controller 3 is connected to the optical devices 2a, 2b. The controller 3 includes an electronic control unit with an I/O device, a processor, a storage etc. The controller 3 includes a ranging calculator 31, a collision determinator 32, and an avoid operation driver 33. The ranging calculator 31 calculates the distance between the first vehicle VE1 (subject vehicle) and the second or third vehicle VE2, VE3 (different vehicle) based on a detection value concerning the ranging by the light receiver 22. The collision determinator 32 (corresponding to a collision determination means) determines whether there is a possibility of collision between the first vehicle VE1 and the second or third vehicle VE2, VE3, based on a calculation result of the ranging calculator 31. When the collision determinator 32 determines that there is a possibility of collision between the first vehicle VE1 and the second or third vehicle VE2, VE3, the avoid operation driver 33 operates a brake of the first vehicle VE1 irrespective of a driver's operation, or operates a steering apparatus of the first vehicle VE1 in order to avoid the collision. Additionally, the avoid operation driver 33 may warn the driver of the first vehicle VE1, or operate an airbag.

The controller 3 further includes a received strength detector 36. Based on a received signal received by the light receiver 22 from the different vehicle VE2, VE3, VE1, the received strength detector 36 detects a received signal strength (RSSI). An adjustment amount calculator 37, which corresponds to an adjustment amount transmitter and an adjustment amount transmission means, is connected to the ranging calculator 31, the received strength detector 36, and the optical devices 2a and 2b. Based on the infrared strength of the received signal from the different vehicle VE2, VE3, VE1 and the distance to the different vehicle VE2, VE3, VE1, the adjustment amount calculator 37 calculates an adjustment amount of the infrared strength with regard to the received signal from the different vehicle VE2, VE3, VE1, and transmits the adjustment amount to the different vehicle VE2, VE3, VE1 through the optical device 2a, 2b.

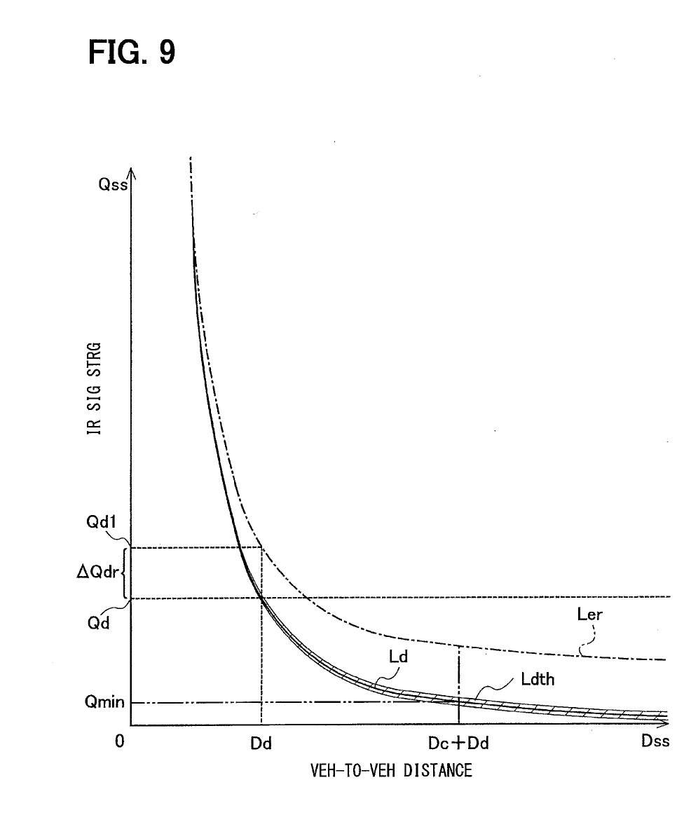

Now, based on FIG. 9, explanation will be given on a method of calculating the adjustment amount of the infrared strength by the adjustment amount calculator 37 of the first vehicle VE1. For example, as shown in FIG. 9, the infrared strength Qss of the received signal received by the first vehicle VE1 from the second vehicle VE2 is in inverse proportion to the square of the distance Dss between the first vehicle VE1 and the second vehicle VE2.

In FIG. 9, the solid line Ld shows an ideal line of the infrared strength Qss as a function of the vehicle-to-vehicle distance Dss. Specifically, when the first vehicle VE1 and the second vehicle VE2 approach each other and a distance therebetween reaches the maximum distance measurable distance Dd (outer edge of the measureable area 6), the infrared light emitted from the light emitter 21 of the first vehicle VE1 is reflected by the second vehicle VE2 and is incident on the light receiver 22, so that the ranging starts. In this case, when the infrared strength of the received signal from the second vehicle VE2, which is received by the forward optical device 2a of the first vehicle VE1, is Qd, the infrared strength at a time when the distance between the first vehicle VE1 and the second vehicle VE2 is the maximum communicable distance (Dc+Dd) is a minimum receivable strength Qmin. For this reason, when the second vehicle VE2 moves out of the communicable area 7 of the first vehicle VE1 (Dss>(Dc+Dd)), the first vehicle VE1 is already prevented from receiving the infrared light from the second vehicle VE2.

As another situation, it is assumed that a relation between the infrared strength and the vehicle-to-vehicle distance becomes the line Ler (shown as the dashed-dotted line in FIG. 9) because the infrared environment around the first vehicle VE1 has changed and the infrared strength Qss with respect to the vehicle-to-vehicle distance Dss has increased. In this case, even if the second vehicle VE2 is out of the communicable area 7 of the first vehicle VE1, the infrared strength of the received signal from the second vehicle VE2 may become larger than the minimum intensity Qmin, and the reception from the second vehicle VE2 occurs.

In this case, in the approaching vehicle detection apparatus 1 of the present embodiment, the adjustment amount calculator 37 of the first vehicle VE1 generates the line Ler based on the infrared strength Qss with respect to the vehicle-to-vehicle distance Dss detected with received strength detector 36, and detects that the line Ler is out of a region Ldth (hatched region in FIG. 9), which has a predetermined width around the line Ld. The adjustment amount calculator 37 calculates an infrared strength difference ΔQdr between Qd1 and Qd as the adjustment amount of the infrared strength, where the Qd1 is the infrared strength on the line Ler at a time when the vehicle-to-vehicle distance is Dd. The adjustment amount of the infrared strength ΔQdr is transmitted to the second vehicle VE2 via the optical device 2a.

Explanation returns to FIG. 7. The controller 3 further includes a strength adjustment driver 38 connected to the optical devices 2a and 2b. The strength adjustment driver 38 (corresponding to a strength adjustment means) adjusts an infrared strength of the transmitted signal at the vehicle-to-vehicle of Dd based on the adjustment amount ΔQdr of the infrared strength received from the different vehicle VE2, VE3, VE1.

The controller 3 is connected to a pyroelectric sensor 4 (corresponding to an infrared detector and an infrared detection means). The pyroelectric sensor 4 detects an infrared amount in space of the surrounding of the vehicle VE1, VE2, VE3.

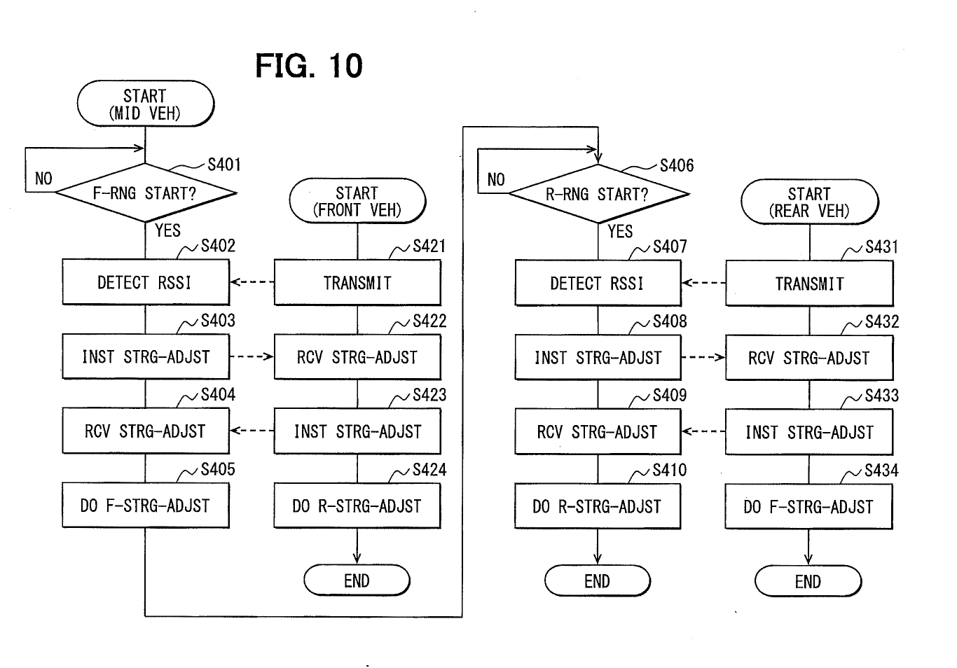

Next, based on FIG. 10, explanation will be given on an infrared strength adjustment method performed by the controllers 3 of the first, second and third vehicle VE1, VE2, VE3. In the following explanation, it is assumed that the positional relationship among the vehicle VE1, VE2, and VE3 is that shown in FIG. 7. In FIG. 10, a middle vehicle corresponds to the first vehicle VE1, and a forward vehicle corresponds to the second vehicle VE2, a rearward vehicle corresponds to the third vehicle VE3. First, it is determined (S401: ranging process) whether the ranging to measure a distance to the second vehicle VE2 (corresponding to the forward vehicle) is started by the optical device 2a of the first vehicle VE1. When the ranging to measure a distance to the second vehicle VE2 is not started, the determination at S401 is repeated.

When the second vehicle VE2 enters into the distance measurable area 6 of the first vehicle VE1 and the ranging to measure the distance to the second vehicle VE2 is started, the process proceeds to S402. Note that at this time, the communication between the vehicles VE1 and VE2 is already established. At S402 (received strength detection process), the received strength detector 36 of the first vehicle VE1 detects the infrared strength of the received signal from the second vehicle VE2 (cf. S421). At this time, if the first vehicle VE1 has not received the signal from the second vehicle VE2, the transmission of the signal is requested to the second vehicle VE2. Next, at S403 (adjustment amount transmission process), the adjustment amount calculator 37 calculates the adjustment amount of the infrared strength based on the infrared strength of the received signal from the second vehicle VE2 and the distance to the second vehicle VE2, and transmits the adjustment amount of the infrared strength towards the second vehicle VE2 through the forward optical device 2a.

At S422, the second vehicle VE2 receives the adjustment amount of the infrared strength from the first vehicle VE1, and the process proceeds to S423 (adjustment amount transmission process). At S423, based on the distance to the first vehicle VE1 and the infrared strength of the received signal from the first vehicle VE1, the second vehicle VE2 calculates an adjustment amount of the infrared strength (not shown in FIG. 10) and transmits the adjustment amount toward the first vehicle VE1 through the rearward optical device 2 like the first vehicle VE1 does.

At S404, the strength adjustment driver 38 of the first vehicle VE1 receives the adjustment amount of the infrared strength from the second vehicle VE2. At S405, the strength adjustment driver 38 of the first vehicle VE1 adjusts the infrared strength of the transmitted signal of the forward optical device 2a based on the received adjustment amount of the infrared strength. At S422, the strength adjustment driver 38 of the second vehicle VE2 receives the adjustment amount of the infrared strength from the first vehicle VE1.

At S424 (corresponding to the strength adjustment process), the strength adjustment driver 38 of the second vehicle VE2 adjusts the infrared strength of the transmitted signal of the rearward optical device 2b based on the received adjustment amount of the infrared strength.

In the above-mentioned flow, S402 to S404 and S421 to S423 correspond to a communication process.

Thereafter, at S406 (ranging process), it is determined whether the ranging to measure the distance to the third vehicle VE3 (corresponding to the rearward vehicle) is started by the rearward optical device 2b of the first vehicle VE1. When the ranging to measure the distance to the third vehicle VE3 (corresponding to the rearward vehicle) is not started, S406 is repeated.

When the third vehicle VE3 enters into the distance measurable area 6 of the first vehicle VE1 and the ranging to measure the distance to the second vehicle VE3 is started by the first vehicle VE1, the process proceeds to S407. At this time, the communication between the vehicles VE1, VE3 is already established. At S407 (received strength detection process), the received strength detector 36 of the first vehicle VE1 detects the infrared strength of the received signal from the third vehicle VE3. At this time, if the first vehicle VE1 has not received the signal from the third vehicle VE3, the transmission of the signal is requested to the third vehicle VE3.

Because the subsequent flow is the same as described above, explanation on S408, S409, S431 to S433 is omitted.

At S410 (corresponding to the strength adjustment process), the first vehicle VE1 receiving the adjustment amount of the infrared strength from the third vehicle VE3 adjusts the infrared strength of the transmitted signal of the rearward optical device 2b based on the received adjustment amount.

At S434 (corresponding to the strength adjustment process), the third vehicle VE3 receiving the adjustment amount of the infrared strength from the third vehicle VE1 adjusts the infrared strength of the transmitted signal of the forward optical device 2b based on the received adjustment amount. In the above-mentioned flow, S407 to S409 and S431 to S433 correspond to a communication process.

As can been seen the above, each time the optical device 2a, 2b detects the distance to the different vehicle VE2, VE3, VE1, the strength adjustment driver 38 adjusts the infrared strength of the transmitted signal.

In the above, the explanation is given on cases where the first vehicle VE1 is a master vehicle and the infrared strength is adjusted in each vehicle VE1, VE2, VE3. Incidentally, when the vehicles VE1, VE2, VE3 approach each other and, the vehicles VE1, VE2, VE3 enter into the distance measurable areas 6 of the counterparty vehicles. In this case, when the second vehicle VE2 establishes the ranging to measure the distance to the first vehicle VE1 earlier, the second vehicle VE2 acts as a master vehicle and the adjustment of the infrared strength between the first and second vehicles VE1 and VE2 is performed. In another case, when the third vehicle VE3 establishes the ranging to measure the distance to the first vehicle VE1 earlier, the third vehicle VE3 acts as a master vehicle and the adjustment of the infrared strength between the first and third vehicles VE1 and VE3 is performed.

In some cases, the vehicles VE1, VE2 and VE3 establish their ranging simultaneously. In this case, the adjustment of the infrared strength may be performed according to such a program that the master vehicle is set to a vehicle that receives the signal from its front side, or the mater vehicle is set, based on the vehicle position detected by GPS, to a most northerly or easterly vehicle among the vehicles.

The approaching vehicle detection apparatus 1 of the present embodiment adjusts the infrared strength of the transmitted signal based on the adjustment amount of the infrared strength received from the different vehicle VE2, VE3, VE1. Thereby, the infrared strength of the transmitted signal can be appropriately set and unnecessary reception in the vehicles VE1, VE2, VE2 can be reduced.

Moreover, the strength adjustment driver 38 adjusts the infrared strength of the transmitted signal each time the optical device 2a, 2b starts detecting the distance to the different vehicle VE2, VE3, VE1. Thereby, when the different vehicle VE2, VE3, VE1 newly approaches, the infrared strength of the transmitted signal can be adjusted in a timely manner, and necessary communication with the approaching vehicle can be performed in a timely manner.

Moreover, when the different vehicle VE2, VE3, VE1 approaches within the distance measurable area 6 smaller than the communicable area 7, the optical device 2a, 2b detects the distance to the different vehicle VE2, VE3, VE1. Therefore, because the signal from the different vehicle VE2, VE3, VE1 is receivable at a time of the establishment of the ranging, it becomes possible to promptly detect its infrared strength.

Moreover, the optical devices 2a, 2b include the forward optical device 2a and the rearward optical device 2b. The forward optical device 2a detects a distance to the second vehicle VE2 in front of the first vehicle VE1, and performs information exchange with the second vehicle VE2. The rearward optical device 2b detects the distance to the third vehicle VE3 in rear of the first vehicle VE1, and performs information exchange with the third vehicle VE3. The forward optical device 2a, which performs the ranging and the communication to the forward vehicle, is separated from the rearward optical device 2b, which performs the ranging and the communication to the rearward vehicle. Therefore, each ranging to measure the distance to the second vehicle VE2 located in front of the first vehicle VE1 and the third vehicle VE3 located in rear of the first vehicle VE1 can be performed with high accuracy. In addition, it becomes possible to improve quality of the communication with the second vehicle VE2 located in front of the first vehicle VE1 and quality of the communication with the third vehicle VE3 located in rear of the first vehicle VE1.

Moreover, in the vehicle VE1, VE2, VE3, because a single optical device 2a, 2b including the light emitter 21 and the light receiver 22 is made to serve a double purpose as the ranging and the communication, the approaching vehicle detection apparatus 1 can be downsized.

Moreover, the approaching vehicle detection apparatus 1 includes the collision determinator 32, which determines a possibility of a collision with the different vehicle VE2, VE3, VE1 based on the detection result of the distance to the different vehicle VE2, VE1 by the optical device 2a, 2b. Therefore, the danger of the collision with the different vehicle VE2, VE1 can be avoided beforehand and the safety of the vehicle VE1, VE2, VE3 can improve.

Moreover, in the approaching vehicle detection method of the present embodiment, the infrared strength of the transmitted signal is adjusted based on the adjustment amount of the infrared strength received from the different vehicle VE2, VE3, VE1. The infrared strength of the transmitted signal can be appropriately set and unnecessary reception in the vehicles VE1, VE2, VE3 can be reduced.

<First Modification of Second Embodiment>

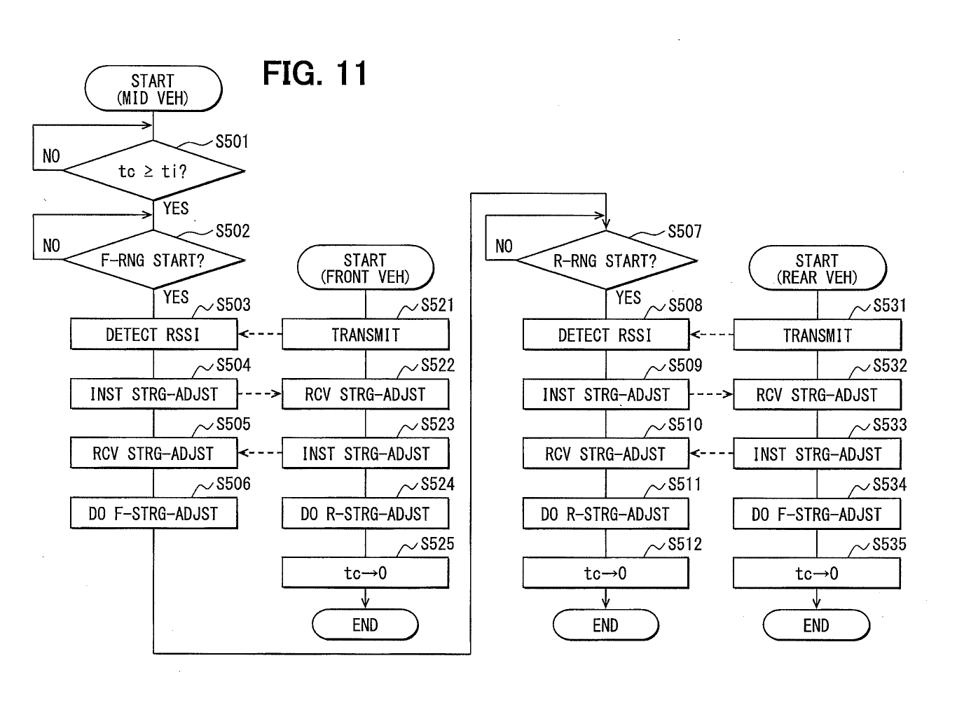

Next, based on FIG. 11, an adjustment method of the infrared strength of a first modification of the second embodiment will be described. A difference from the second embodiment will be mainly explained. In the following explanation, it is assumed that the positional relationship among. the vehicle VE1, VE2, and VE3 is that shown in FIG. 7. In FIG. 11, a middle vehicle corresponds to the first vehicle VE1, and a forward vehicle corresponds to the second vehicle VE2, a rearward vehicle corresponds to the third vehicle VE3. In the present modification, it is determined at S501 whether a timer tc inside the controller 3 of the first vehicle VE1 becomes equal to or greater than a threshold ti. When the timer tc is less than the threshold ti, S501 is repeated. When the timer tc becomes equal to or greater than the threshold ti, it is determined whether or not the ranging to measure the distance to the second vehicle Ve2 is started by the optical device 2a of the first vehicle VE1.

Out of the subsequent flow, S503 to S511, S521 to S524, and S531 to S534 are the same as those in the second embodiment. Thus, explanation on it is omitted.

At S511, the controller 3 of the first vehicle VE1 adjusts the infrared strength of the transmitted signal of the rearward optical device 2b. Thereafter, the process proceeds to S512 at which the timer tc is reset.

At S524, the controller 3 of the second vehicle VE2 adjusts the infrared strength of the transmitted signal of the rearward optical device 2b. Thereafter, the process proceeds to S525 at which the timer tc is reset.

At S534, the controller 3 of the third vehicle VE3 adjusts the infrared strength of the transmitted signal of the forward optical device 2a. Thereafter, the process proceeds to S535 at which the timer tc is reset.

As described above, in the approaching vehicle detection apparatus 1 of the present modification, the strength adjustment driver 38 adjusts the infrared strength of the transmitted signal each time a predetermined time ti has elapsed. Therefore, it becomes possible to adjust the infrared strength in response to a surrounding environment change resulting from passage of time.

<Second Modification of Second Embodiment>

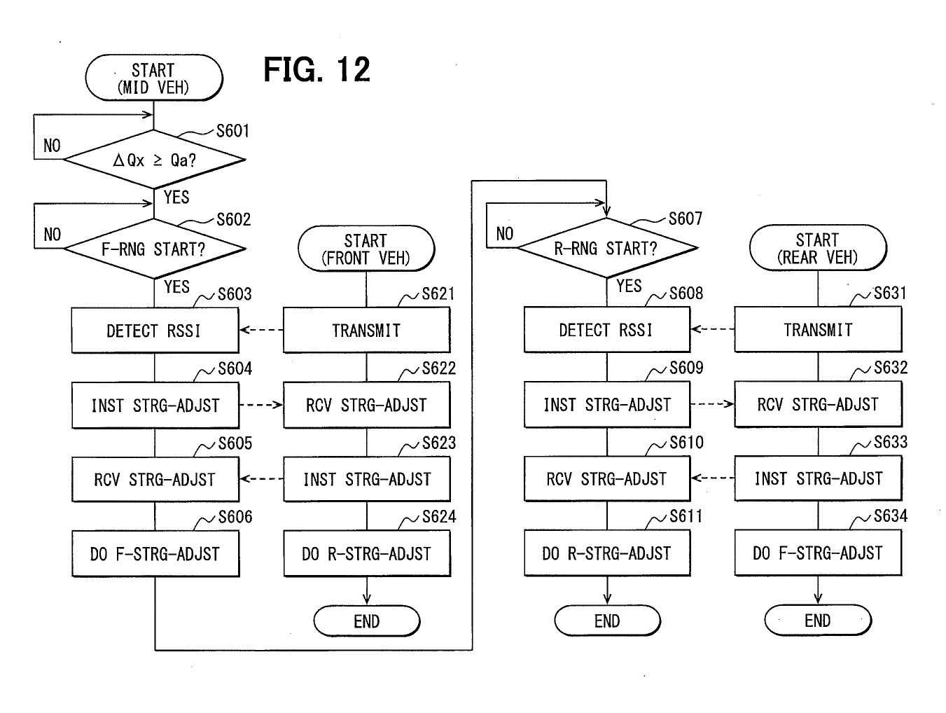

Next, based on FIG. 12, an adjustment method of the infrared strength of a second modification of the second embodiment will be described. A difference from the second embodiment will be mainly explained. In the following explanation, it is assumed that the positional relationship among the vehicle VE1, VE2, and VE3 is that shown in FIG. 8. In FIG. 12, a middle vehicle corresponds to the first vehicle VE1, and a forward vehicle corresponds to the second vehicle VE2, a rearward vehicle corresponds to the third vehicle VE3. In the present modification, at S601, it is determined whether of not the change ΔQx in the infrared amount in the surrounding space detected with the pyroelectric sensor 4 of the first vehicle Ve1 becomes greater than or equal to a change amount threshold Qa. When the change ΔQx in the infrared amount is less than the change amount threshold Qa, S601 is repeated. When the change ΔQx in the infrared amount becomes equal to or greater than the change amount threshold Qa, the process proceeds to S602. At S602, it is determined whether the ranging to measure a distance to the second vehicle VE2 is started by the forward optical device 2a of the first vehicle VE1.

Out of the subsequent flow, S603 to S611, S621 to S624, and S631 to S634 are the same as those in the second embodiment. Thus, explanation on it is omitted.

As described above, in the approaching vehicle detection apparatus 1 of the present modification, the strength adjustment driver 38 adjusts the infrared strength of the transmitted signal each time the change ΔQx in the infrared amount in the surrounding space becomes equal to or greater than the change amount threshold Qa.

In the present modification, the strength adjustment driver 38 adjusts the infrared strength of the transmitted signal each time the pyroelectric sensor 4 detects a certain change in the infrared amount in the surrounding space. Therefore, it becomes possible to adjust the infrared strength in response to the change in the infrared amount in the surrounding space.

<Further Modifications of Second Embodiment>

The above second embodiment and modification thereof do not limit embodiments and can be modified and extended in various ways.

In place of IRLED, the light source of the optical device 2a, 2a may include a laser light source or a filament type infrared light source. In place of PSD, the photo detector of the optical device 2a, 2b may include a CMOS image sensor or a CCD sensor.

The approaching vehicle detection apparatus 1 is applicable to a driverless vehicle as well as a manned vehicle.

Moreover, when the received strength detector 36 detects the infrared strength Qss of the received signal concerning the vehicle-to-vehicle distance, the infrared strength Qss at a time when the distance between the vehicles VE1, VE2, VE3 is the maximum range Dd may not be necessarily detected. Alternatively, the infrared strength Qss at a time when the distance between the vehicles VE1, VE2, VE3 is another distance may be detected.

Moreover, when the received strength detector 36 detects the infrared strength Qss of the received signal concerning the vehicle-to-vehicle distance Dss, the line illustrated in FIG. 9 may be generated based on multiple infrared strengths Qss corresponding to multiple measured vehicle-to-vehicle distances Dss.

Moreover, when the adjustment amount calculator 37 calculates the adjustment amount of the infrared strength Qss, the adjustment amount of the infrared strength Qss at a time when the distance between the vehicles VE1, VE2, VE3 is the maximum range Dd may not be necessarily calculated. Alternatively, the adjustment amount of the infrared strength Qss at a time when the distance between the vehicles VE1, VE2, VE3 is another distance may be calculated.

Moreover, when the adjustment amount calculator 37 calculates the adjustment amount of the infrared strength Qss, the adjustment amount calculator 37 may calculate multiple adjustment amounts based on multiple infrared strengths Qss corresponding to multiple measured vehicle-to-vehicle distances Dss, and calculate an average value of the multiple adjustment amounts as a final adjustment amount.

Moreover, in place of the pyroelectric sensor 4, the infrared detection device may be a photoelectric tube, a photo-conducted type element, a photo voltage type element, a thermocouple type element, or the like.

Embodiments of the present disclosure have been illustrated above. However, the above-illustrated embodiments do not limit embodiments of the present disclosure and can be variously modified without departing from the spirit of the present disclosure. For example, embodiments of the present disclosure include an embodiment provided by combining technical parts in different embodiments above and an embodiment provided as part of the embodiment above.

What is claimed is:

1. An approaching vehicle detection apparatus mounted to a subject vehicle to detect a different vehicle approaching the subject vehicle, the approaching vehicle detection apparatus comprising:
a ranging device that detects a distance to the different vehicle based on receipt of an infrared light that is transmitted toward the different vehicle and reflected by the different vehicle;
a communication device that performs transmission and receipt of a signal of infrared light between the subject vehicle and the different vehicle to exchange information when the different vehicle approaches the subject vehicle within a first vehicle-to-vehicle distance; and
a ranging synchronization device that, based on the signal of the communication device, makes transmission timing of the infrared light differ from the subject vehicle to the different vehicle.

2. The approaching vehicle detection apparatus according to claim 1, wherein:
the ranging device detects the distance to the different vehicle when the different vehicle approaches the subject vehicle within a second vehicle-to-vehicle distance smaller than the first vehicle-to-vehicle distance.

3. The approaching vehicle detection apparatus according to claim 1, wherein:
the ranging synchronization device pre-stores a program for making the subject vehicle and the different vehicle differ from each other in the transmission timing of the infrared light.

4. The approaching vehicle detection apparatus according to claim 1, further comprising:
a single optical device that includes an infrared light emitter and an infrared light receiver, and that serves as both of the ranging device and the communication device,
wherein the single optical device is mounted in each of the subject vehicle and the different vehicle.

5. The approaching vehicle detection apparatus according to claim 1, further comprising:
a collision determinator that determines a possibility of a collision with the different vehicle based on a detection result of the distance to the different vehicle by the ranging device.

6. The approaching vehicle detection apparatus according to claim 1, wherein:
the ranging synchronization device pre-stores a program for stopping transmitting the infrared light that is for detecting the distance to the different vehicle.

7. An approaching vehicle detection method comprising:
performing a ranging process, including transmitting an infrared light between a subject vehicle and a different vehicle and detecting a distance to the different vehicle based on receipt of the infrared light that is reflected by the different vehicle;
performing a communication process, including transmission and receipt of a signal of infrared light signal between the subject vehicle and the different vehicle to exchange information when the different vehicle approaches the subject vehicle within a first vehicle-to-vehicle distance; and
performing a ranging synchronization process, including making transmission timing of the infrared light differ from the subject vehicle to the different vehicle based on the signal transmitted and received in the communication process.

8. An approaching vehicle detection apparatus mounted to a subject vehicle to detect a different vehicle approaching the subject vehicle, comprising:
a ranging device that detects a distance to the different vehicle based on receipt of an infrared light that is transmitted toward the different vehicle and reflected by the different vehicle;
a communication device that performs transmission and receipt of a signal of infrared light between the subject vehicle and the different vehicle to exchange information when the different vehicle approaches the subject vehicle within a first vehicle-to-vehicle distance;
a received strength detection device that detects an infrared strength of the received signal from the different vehicle;
an adjustment amount transmission device that calculates an adjustment amount with regard to the received signal from the different vehicle based on the infrared strength of the received signal from the different vehicle and the distance to the different vehicle, and transmits the calculated adjustment amount to the different vehicle; and
a strength adjustment device that adjusts an infrared strength of the transmitted signal, which is transmitted to the different vehicle, based on an adjustment amount of an infrared strength received from the different vehicle.

9. The approaching vehicle detection apparatus according to claim 8, wherein:
the ranging device detects the distance to the different vehicle when the different vehicle approaches the subject vehicle within a second vehicle-to-vehicle distance smaller than the first second vehicle-to-vehicle distance; and
the strength adjustment device adjusts the infrared strength of the transmitted signal each time the ranging device starts detecting the distance to the different vehicle.

10. The approaching vehicle detection apparatus according to claim 8, wherein:
the strength adjustment device adjusts the infrared strength of the transmitted signal each time a predetermined time has elapsed.

11. The approaching vehicle detection apparatus according to claim 8, further comprising:
an infrared light detection device that detects an infrared amount in space, wherein:
the strength adjustment device adjusts the infrared strength of the transmitted signal each time the infrared light detection device detects that the infrared amount in space is changed by a specific amount.

12. The approaching vehicle detection apparatus according to claim 8, wherein:
the ranging device includes
a forward ranging unit detecting a distance to a forward vehicle, which is the different vehicle located in front of the subject vehicle, and
a rearward ranging unit detecting a distance to a rearward vehicle, which is the different vehicle located in rear of the subject vehicle;
the communication device includes
a forward communication unit exchanging information with the forward vehicle, and
a rearward communication unit exchanging information with the rearward vehicle.

13. The approaching vehicle detection apparatus according to claim 8, further comprising:
a single optical device that includes an infrared light emitter and an infrared light receiver, and that serves as both of the ranging device and the communication device,
wherein the single optical device is mounted in each of the subject vehicle and the different vehicle.

14. An approaching vehicle detection method comprising:
performing a ranging process, including transmitting an infrared light between a subject vehicle and a different vehicle and detecting a distance to the different vehicle based on receipt of the infrared light that is reflected by the different vehicle;
performing a communication process, including performing transmission and receipt of a signal of infrared light between the subject vehicle and the different vehicle to exchange information when the different vehicle approaches the subject vehicle within a first vehicle-to-vehicle distance;
performing a received strength detection process, including detecting an infrared strength of the received signal from the different vehicle in the communication process;
performing an adjustment amount transmission process, including calculating an adjustment amount with regard to the received signal from the different vehicle based on the infrared strength of the received signal from the different vehicle and the distance to the different vehicle, and transmitting the adjustment amount to the different vehicle; and
performing a strength adjustment process, including adjusting an infrared strength of the transmitted signal, which is transmitted to the different vehicle, based on an adjustment amount of an infrared strength received from the different vehicle.
